(19) United States
(12) Patent Application Publication
(10) Pub. No.: US 2026/0100751 A1
(43) Pub. Date: Apr. 9, 2026

(54) NETWORK-CONTROLLED REPEATER OPERATION DURING BEAM RECOVERY PROCEDURE OF THE BACKHAUL LINK

(71) Applicant: Lenovo (Singapore) Pte.Ltd., Singapore (SG)

(72) Inventors: Ali Ramadan Ali, Kraiburg am Inn (DE); Karthikeyan Ganesan, Nauheim (DE)

(21) Appl. No.: 19/114,432

(22) PCT Filed: Sep. 26, 2023
(86) PCT No.: PCT/IB2023/059557

§ 371 Date: Mar. 21, 2025

Related U.S. Application Data
(60) Provisional application No. 63/377,527, filed on Sep. 28, 2022.

(51) Int. Cl. H04B 7/06; H04W 24/08; H04W 24/10

(52) U.S. Cl. CPC H04B 7/06964; H04W 24/08; H04W 24/10

(57) ABSTRACT

Various aspects of the present disclosure relate to a device and method for a network-controlled repeater (NCR) device to detect, indicate, and recover from a backhaul failure. The method includes communicating, by the NCR device with: (i) base station(s) via a control link or a backhaul link and (ii) a user equipment (UE) via an access link. A beam association is determined of the control link and the backhaul link. The method includes determining that the control link is communicated on a first beam and the backhaul link is communicated on a second beam of the base station(s). In response, the method includes monitoring a reference signal received on the backhaul link for an indication of failure of the backhaul link. The method includes transmitting a request for backhaul beam recovery on the control link in response to detecting the indication of failure of the backhaul link.

### PRIORITY APPLICATION

The application claims priority to U.S. Provisional Application No. 63/377,527, filed Sep. 28, 2022, the content of which is fully incorporated herein.

### TECHNICAL FIELD

The present disclosure relates to wireless communications, and more specifically to repeating wireless communication using a repeater device

### BACKGROUND

A wireless communications system may include one or multiple network communication devices, including base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

Coverage is a fundamental aspect of cellular network deployments. Mobile operators rely on different types of network nodes to offer blanket coverage in their deployments. Deployment of regular full-stack cells is one option but may not be always technically possible or economically viable. As a result, new types of network nodes have been considered to increase mobile operators' flexibility for their network deployments. For example, Integrated Access and Backhaul (IAB) is a new type of network node not requiring a wired backhaul. Another type of network node is a radio frequency (RF) repeater that simply amplifies-and-forwards any signal that the RF repeater receives. RF repeaters have seen a wide range of deployments in 2G, 3G and 4G to supplement the coverage provided by regular full-stack cells. The 5G New Radio (NR) radio access technologies (RATs) have RF and Electromagnetic Compatibility (EMC) requirements for such RF repeaters for NR targeting both Frequency Range 1 (FR1) and Frequency Range 2 (FR2).

### SUMMARY

The present disclosure relates to methods, apparatuses, and systems that provide procedures and signaling for a network-controlled repeater (NCR) device for detecting, indicating, and recovering from a beam failure of a backhaul link. In particular, backhaul failure recovery is supported when the NCR device receives a first link such as a control link and a second link such as a backhaul link from different beams of at least one network device, such as a base station.

Some implementations of the method and apparatuses described herein may include a method for wireless communication at a repeater device. In one or more embodiments, the method may include communicating, via at least one transceiver of a repeater device with: (i) at least one network device of a network via (a) a first link or (b) a second link; and (ii) a user device or user equipment (UE) via a third link. The method may include determining a beam association of the first link and the second link established via at the least one transceiver. The method may include determining that the first link is communicated on a first beam and the second link is communicated on a second beam of the at least one network device. In response, the method may include monitoring a reference signal received on the second link for an indication of backhaul failure of the second link. The method may include transmitting a request for backhaul beam recovery on the first link in response to detecting the indication of backhaul failure of the second link.

### BRIEF DESCRIPTION OF THE DRAWINGS

FIG. 1 illustrates an example of a wireless communications system enabling repeating of wireless communication by a network-controller repeater (NCR) device, in accordance with aspects of the present disclosure.

FIG. 2 illustrates a portion of the wireless communications system having a network device that uses different component carriers for control and forward links to the NCR device for extending a coverage area to user equipment (UE), in accordance with aspects of the present disclosure.

FIG. 3 illustrates a portion of the wireless communications system having two Transmission Reception Points (TRPs) that respective provide a control link and a forward link to the NCR device for extending a coverage area to a UE, in accordance with aspects of the present disclosure.

FIG. 4 illustrates a block diagram of a device that performs repeating of wireless communication, in accordance with aspects of the present disclosure.

FIG. 5 illustrates a flowchart of a method performed by a user device that supports beam recovery for a backhaul with an NCR device when different beams are used for the control and forward links on the backhaul, in accordance with aspects of the present disclosure.

### DETAILED DESCRIPTION

While a conventional RF repeater presents a cost-effective means of extending network coverage to a communications system, the RF repeater has its limitations. An RF repeater simply does an amplify-and-forward operation without being able to take into account various factors that could improve performance. Such factors may include information on semi-static and/or dynamic downlink/uplink configuration, adaptive transmitter/receiver spatial beamforming, ON-OFF status, etc. A network-controlled repeater (NCR) is an enhancement over conventional RF repeaters with the capability to receive and process side control information from the network. Side control information may include time division duplex (TDD) switching, timing information, power control, as well as common and user equipment (UE) dedicated spatial information for beamforming.

NCR devices contain two main components/functions: (i) an NCR mobile terminal (NCR-MT) responsible for receiving the side control information via a control link (C-Link); and (ii) NCR forward components (NCR-Fwd) are responsible for amplifying and forwarding uplink (UL)/downlink (DL) physical (PHY) channels/signals for both a backhaul link with the network and an access link with the UEs. The NCR-MT and NCR-Fwd can support multiple component carriers (different frequency bands), which can require using different beams. In an example, using different component carriers for the forward link and the C-link may require different beams. In another example, using different Transmission Reception Points (TRPs) or remote radio heads for the forward link that the C-link may require different beams. Using different beams necessities different treatment for beam recovery procedure. Recovery of the C-link can be handled by the legacy procedure. Although the NCR device and the TRP(s) are at fixed locations, there is a possibility that the beam between the TRP(s) and the NCR device is blocked. In an example, a mobile obstacle may move between the TRP(s) and the NCR device.

In the present disclosure, a solution is provided for indicating/recovering and changing repeater operation when a beam failure of the backhaul link occurs. In one aspect, the present disclosure provides for configuration to the NCR-MT for measuring Beam Failure Recovery (BFR) Channel State Information (CSI) Reference Signal (RS) candidate beams of the backhaul-forward link. In another aspect, the present disclosure provides configuration for reporting the beam failure recovery request for the backhaul-forward link. In an additional aspect, the present disclosure provides a new configuration for handing NCR-Fwd operation during the beam recovery procedure.

In one or more aspects of the present disclosure, an apparatus and method are provided at an NCR device for beam failure recovery including receiving, by the NCR device from a network device such as New Radio Base Node (gNB), a first configuration for beam recovery of the backhaul-forward link. The NCR device receives from the gNB a second configuration for handling the repeater operation during the beam recovery procedure. The NCR device as configured by the first and the second configurations transmits, to the network, indication for beam failure detection and recovery.

In one or more embodiments, the first configuration includes information about the reference signal for beam recovery detection transmitted on the backhaul-forward link. In one or more embodiments, the first configuration includes a threshold for triggering the beam failure recovery request of the backhaul-forward link. In one or more embodiments, the first configuration contains information for sending the beam failure request for recovering the backhaul-forward link on the UL of the C-link and configuration for receiving the gNB response for beam recovery. In one or more embodiments, the NCR device triggers the beam failure recovery request in response to detecting one of the measured candidate beams having a measured value that is above a predefined threshold value. In one or more embodiments, the NCR device sends a request that includes an identifier of the measured candidate beam having the measured value that is above the predefined threshold value and includes identification of a TRP that transmits the identified candidate beam.

In one or more embodiments, the second configuration contains indication to the NCR device to switch access link transmission/reception OFF during the beam failure recovery of the forward link when the quality of the serving backhaul beam is below a certain quality threshold. In one or more embodiments, the NCR device receives an indication from the network to switch access link transmission/reception OFF when the measured energy at a radio frequency (RF) circuit of the forward link is below a certain energy threshold. In response, the repeater device is configured to indicate the OFF state of the access link to the network.

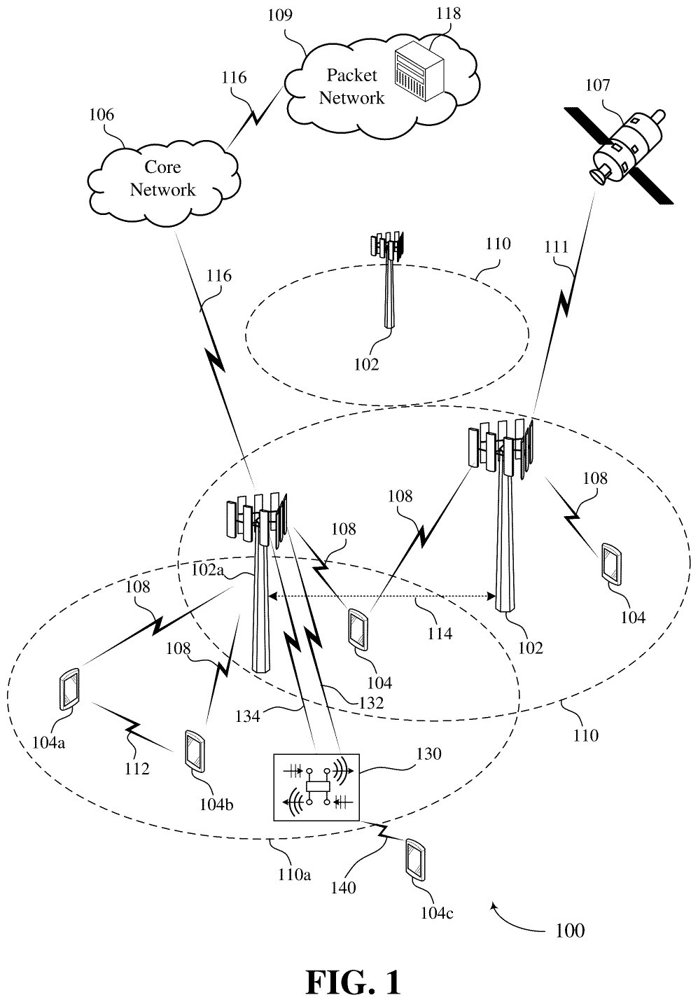

FIG. 1 illustrates an example of a wireless communications system 100 enabling repeating of wireless communication by a network-controller repeater (NCR) device, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communicate with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Network-controlled repeater (NCR) devices 130 may enable network device 102a to communicate with UE 104c that is outside of coverage area 110a. Network device 102a communicates via control link 132 and backhaul link 134 with NCR device 130. NCR device 130 repeats uplink and downlink signals on backhaul link 134 on access link 140 with UE 104c. NCR device 130 efficiently extends the network coverage in both uplink and downlink with the help of side control information from the network. This information may include time division duplex (TDD) switching, timing information, power control, as well as common and UE dedicated spatial information for beamforming. Aspects of the present disclosure may apply more generally to communication links referred to with different labels. In one or more embodiments, the control link 132 may generally be a first link, the backhaul link 134 may generally be a second link, and the access link 140 may generally be a third link.

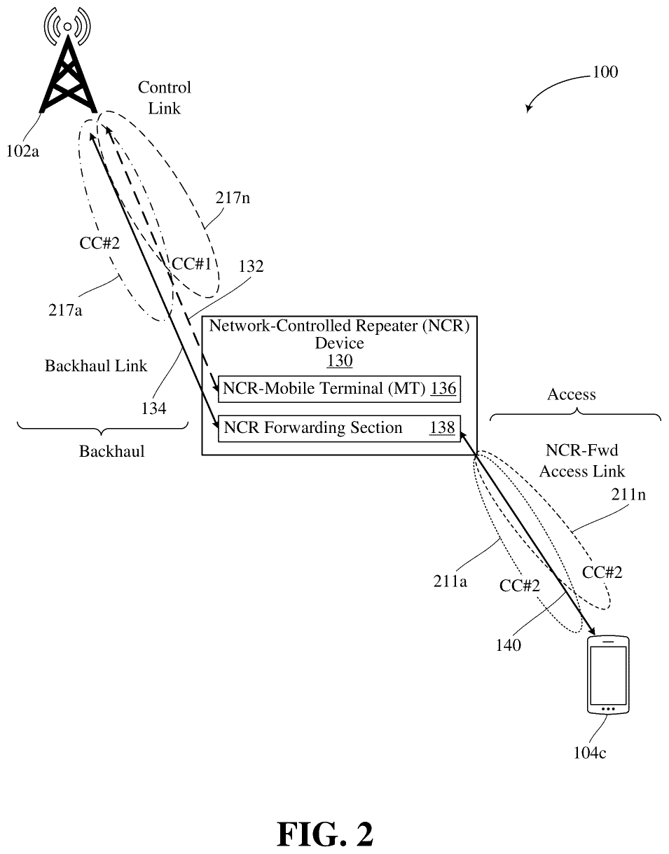

FIG. 2 illustrates a portion of the wireless communications system 100 including the network device 102a, an NCR device 130 and a UE 104c that is outside of a coverage area 110a (FIG. 1) for the network device 102a. Wireless communications system 100 may extend a coverage area 110a for the network device 102a by including an NCR device 130 that is able to reach a UE 104c. NCR device 130 communicates with the network device 102a via both a side control link 132, which may be referred to as a “C-link”, and via a backhaul link 134. The side control link 132 terminates at the NCR device 130 that accordingly acts as an NCR mobile terminal (NCR-MT) 136. The NCR device 130 includes an NCR forwarding section 138 that receives and amplifies a DL radio frequency (RF) signal received via the backhaul link 134 and forwards the DL RF signal with minimal delay via an access link 140 to the UE 104c. Similarly, the NCR forwarding section 138 receives and amplifies an UL RF signal received via the access link 140 and forwards the UL RF signal with minimal delay via the backhaul link to the network device 102a. The network device 102a is able to configure the NCR forwarding section 138 via configuration information sent via the side control link 132 to the NCR-MT 136.

Network device 102a has capabilities such as supported beams 217a through 217n for supporting control link 132 and NCR-Fwd access link 134. NCR device 130 has capabilities such as supported beams 211a through 211n for supporting NCR-Fwd access link 140 for UE 104c. In an example, beam 217a of network device 102a carries second component carrier (CC#2) for backhaul link 134. Beam 217n of network device 102a carries first component carrier (CC#1) for control link 132. Beams 211a and 211n of NCR device 130 both carry second component carrier (CC#2) for NCR-Fwd access link 140. Network device 102a provides a single TRP. However, different component carriers on beams 217a for backhaul link 134 and beam 217n for the control link 132 present an issue for backhaul beam recovery.

The NCR device 130 is connected to a single TRP (network device 102a) for both the control link 132 and the forward link 134, and the forward link 134 has a different component carrier than the control link 132. Although not always the case, an implication of using different component carriers is channel behaviors may also be different for the two component carriers, resulting in use of the two different beams 217a and 217n. When the NCR device 130 cannot listen to the reference signals, at least Beam Failure Detection Reference Signal (BFD-RS) in the forward link, the beam failure of the backhaul-forward link 134 cannot be identified.

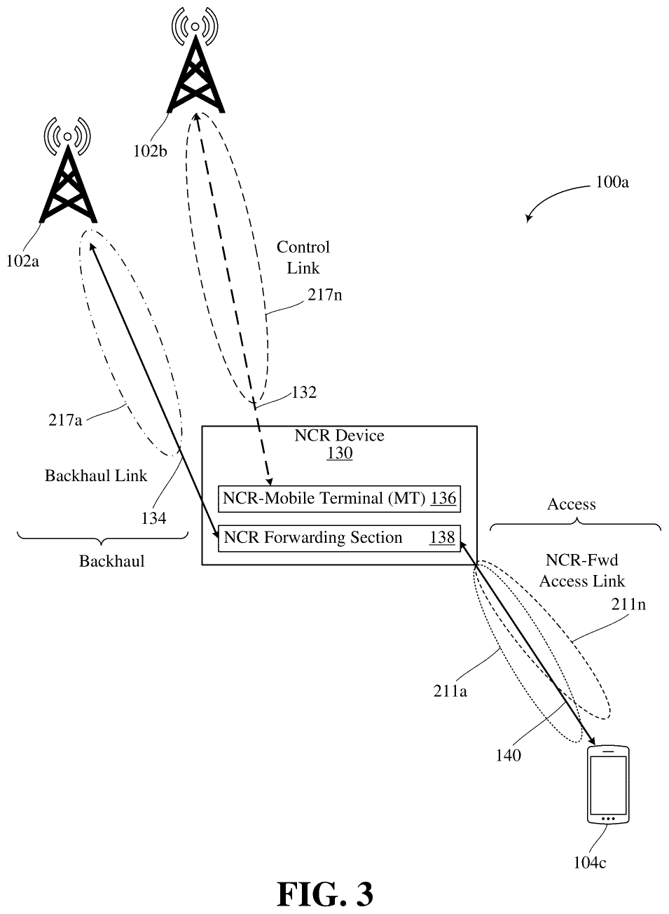

FIG. 3 is an example of the wireless communications system 100a including the network devices 102a-102b, an NCR device 130 and a UE 104c that is outside of a coverage area 110a (FIG. 1) for the network device 102a. Communication system 100a is similar to communication system 100 (FIG. 2) except that the challenge to backhaul beam recovery originates from having two TRPs. Network device 102a as a first TRP provides beam 217a for the backhaul link 134. Network device 102b as a second TRP provides beam 217n for the control link 132.

When the NCR device 130 is connected to multiple TRPs (e.g., network devices 102a-102b) with at least one TRP has a control link 132 to the NCR device 130, the beams 217n used for the control link 132 from one TRP (102b) and a beam 217a used for the forward link 134 from another TRP (102a) are different due to the different spatial locations of the TRPs (102a-102b). When the repeater cannot listen to the reference signal (at least BFD-RS) of the forward link 134, the beam failure of the backhaul forward link 134 cannot be identified and cannot be recovered. Aspects of the present disclosure provide a configuration for the NCR device 130 to measure the beam failure of the backhaul forward link 134 when a different beam is used for the forward link 134 than the control link 132. The NCR device 130 with the configuration can report the failure in the UL of the control link 132 to the serving cell for beam recovery, such as network device 102a (FIG. 2) and network device 102b (FIG. 3).

In a first embodiment, Embodiment 1, the present disclosure provides a configuration for beam recovery detection and indication for the NCR backhaul-forward link. According to embodiment 1, the NCR-MT 136 is configured by the network to measure reference signals of the forward link for beam recovery procedure of the forward backhaul link. Wherein the reference signals can be the BFR-CSI-RS of candidate beams for beam recovery specific for the backhaul-forward link. For different component carriers (CCs) case (FIG. 2), e.g., in case of carrier aggregation, the NCR-MT 136 maybe operates on one CC while the forward link works on a different CC. In this case two beam recovery procedures are performed by the NCR-MT 136. For the control link 132, the, the NCR-MT follows the legacy procedure for beam detection and recovery. For the backhaul link, the NCR-MT 136 follows the backhaul beam recovery configuration provided by the gNB. The NCR MT 136 measures the BFD-RS of the forward link 134. The NCR device 130 is configured to simultaneously receive both the side control information on the first component carrier and switches to the second component carrier on the configured time slots of the BFD-RS to measure the other component carrier used for the forward link 134. When the NCR device 130 detects that the serving backhaul-forward link 134 goes below a predefined threshold, the NCR device 130 starts measuring other candidate beams 217a-217n. If one of the measured candidate beams 217a-217n has beam quality larger than the threshold, then the NCR device 130 triggers a beam recovery request in the UL of the control link 132, without Physical Random Access Channel (PRACH) transmission.

With continued reference to FIG. 3, a similar backhaul beam recovery configuration is provided for multiple TRPs with at least one of the TRPs (102b) being used to control the NCR device 130 via a control link 132 (FIG. 3) while other TRPs (102a) transmit the data (forward link 134) to be forwarded by the NCR device 130 to the UEs 104c. In this scenario, the beam 217n appropriate for the control link 132 and the beam 217a appropriate for the forward link 134 may be different. Hence, beam detection and beam failure indication need to be performed for control and forward links 132 and 134 separately. Network device 102b, such as a gNB, configures the NCR device 130 with BFR-CSI-RS of the connected TRPs. The repeater is configured to measure the BFD-RS of the indicated beam candidates.

Once a failure is detected in the backhaul-forward link 134, the NCR device sends the beam failure recovery request with the measured candidate beam with best quality of the forward backhaul link 134 in the UL of the control link 132 without PRACH transmission. The request may contain the new candidate beam and/or the TRP that transmits that beam. The request can be sent on uplink control information (UCI) over Physical Uplink Shared Channel (PUSCH)/Physical Uplink Control Channel (PUCCH) of the control link 132. The network device 102b sends a response of the beam recovery request in DL of the control link 132 control using RRC and/or DCI. The response includes information about a new beam configuration of the backhaul-forward link 134.

In a second embodiment, Embodiment 2, the present disclosure provides a configuration for handling the NCR-Fwd operation during a beam recovery procedure. According to embodiment 2, the NCR-MT 136 is configured by the network with two thresholds for backhaul beam measurement and indication for handling the repeater operation during the backhaul beam recovery procedure. The NCR device 130 is configured with the first threshold (Thr1) for triggering the beam failure recovery request if the backhaul beam quality goes below the threshold. The second threshold (Thr2) is used for handling the forward link operation at the NCR device 130. The first threshold (Thr1) is greater than the second threshold (Thr2). The NCR device 130 is (pr-)configured by the network device 102b to switch OFF the access link transmission/reception in case of beam failure/radio link failure at the backhaul forward link 134. In one implementation, the NCR device 130 measures the RS of the serving beam and the candidate beams. When the NCR device 130 detects that all the measured candidate beams of the backhaul forward link 134 are not satisfying the required threshold, then the NCR device 130 autonomously switches NCR forwarding section 138 OFF for access transmission/reception for power saving and interreference avoidance. In addition, the NCR device 130 triggers a beam failure recovery request of the forward link 134 to the network device 102b in the control link 132. When the NCR device 130 detects that the quality of the backhaul forwarding serving beam is below the second threshold (Thr2), the NCR device 130 may switch NCR forwarding section 138 OFF for access link transmission/reception OFF until the backhaul link beam is recovered.

In another implementation, when the NCR forwarding section 138 is not able to listen to the reference signals sent on the backhaul forward link 134 or is not configured to listen to the reference signals for beam recovery of the backhaul forward link 134, the NCR forwarding section 138 may receive energy detection information from the RF circuit of the forward link (NCR forwarding section 138). When the energy goes below a certain predefined threshold, the repeater sends an indication to the network about the failure of the backhaul-forward link. When the detected energy at the RF circuit goes below another threshold (lower than the required value for forwarding the signal to the UE(s) 104c, the NCR device 130 switches the access link transmission/reception OFF until the backhaul beam is recovered.

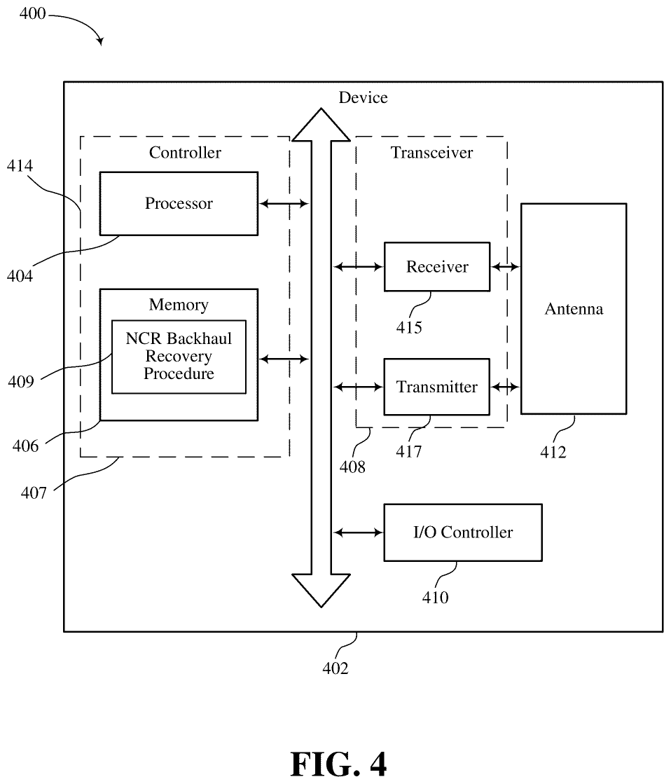

FIG. 4 illustrates an example of a block diagram 400 of a device 402 that supports beam indication for an NCR device, in accordance with aspects of the present disclosure. The device 402 may be an example of a network entity or network device 102 or a UE 104 (FIG. 1) as described herein. The device 402 may support wireless communication with one or more network entities or network devices 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 407 includes the processor 404 that configures the device 402 to perform the functionality of the present disclosure. The processor 404 of the controller 407 is communicatively coupled to the memory 406 to execute program code. Controller 407 may include dedicated memory, which is a portion of memory 406 that is solely accessible by the processor 404. In some implementations, the processor 404 and the memory 406 coupled with the processor 404 within a controller 407 may be configured to perform one or more of the functions as a controller 407 described herein (e.g., executing, by the processor 404, instructions stored in the memory 406). In an example, the processor 404 of a device controller 414 executes an NCR beam indication application 409 to function as an NCR-MT in determining a beam indication for configuring a transceiver 408 of the device 402 to perform NCR forwarding.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor 404. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally using one or more receivers 415 and one or more transmitters 417, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

According to aspects of the present disclosure, the device 402 may be an NCR device 130 (FIGS. 1-3) for repeating wireless communication. The device 402 has the at least one transceiver 408 that includes at least one receiver 415 and at least one transmitter 417 that enable the device 402 to communicate with a network entity or network device 102a and to a user device such as UE 104a (FIG. 1). In particular, the at least one transceiver 408 enables the device 402 to communicate: (i) with at least one network device 102a (FIG. 1) of a wireless communications system 100 (FIG. 1) via (a) a control link 132 (FIGS. 1-3) or (b) a backhaul link 134 (FIGS. 1-3) ; and (ii) with a user device (UE 104a (FIG. 1)) via an access link 140 (FIGS. 1-3) . A controller 414 of the device 402 is communicatively coupled to the at least one transceiver 408. The controller 407 determines a beam association of the first link and the second link established via at the least one transceiver 408. The controller 407 determines that the first link is communicated on a first beam and the second link is communicated on a second beam of the at least one network device. In response, the controller 407 monitors a reference signal received on the second link for an indication of backhaul failure of the second link. The controller 407 transmits a request for backhaul beam recovery on the first link in response to detecting the indication of backhaul failure of the second link.

In one or more embodiments, the controller 407 receives, on the first link, a first configuration for beam recovery of the second link. The controller 407 applies the first configuration to the at least one transceiver to determine the beam association of the first link and the second link and to monitor the reference signal received on the second link. In one or more particular embodiments, the first configuration includes information about monitoring signal quality of the reference signal transmitted on the second link for beam recovery detection. In one or more particular embodiments, the first configuration includes a first threshold for comparing to a signal quality value of the reference signal to indicate the backhaul failure. In one or more particular embodiments, the first configuration includes information for sending the request for backhaul beam recovery on an uplink of the first link and includes a beam recovery configuration for receiving a response for beam recovery via a downlink of the first link.

In one or more embodiments, the controller 407 detects the indication of backhaul failure of the second link. In response, the controller 407 measures reference signals respectively received from candidate beams transmitted by the at least one network device. The controller 407 compares the measured reference signals to a first threshold. The controller 407 transmits the requests for backhaul beam recovery on the first link further in response to identifying at least one candidate beam having a corresponding measured reference signal that is greater than the first threshold. In one or more particular embodiments, the controller 407 transmits, within the requests, a corresponding beam identifier for the at least one candidate beam and a corresponding identifier for a Transmission Reception Point (TRP) that transmitted the at least one candidate beam.

In one or more particular embodiments, the controller 407 receives, on the first link, a second configuration comprising a second threshold that is less than the first threshold for handling repeater operation during a beam recovery procedure. The controller 407 compares signal quality of the second link to the second threshold. The controller 407 turns off transmissions and receptions by the repeater device on the third link in response to the signal quality being less than the second threshold.

In one or more particular embodiments, the controller 407 receives, on the first link, a second configuration comprising a second threshold for handling repeater operation during a beam recovery procedure. The controller 407 monitors radio frequency (RF) received energy of the second link. The controller 407 compares the RF received energy of the second link to the second threshold. The controller 407 turns off transmissions and receptions by the repeater device on the third link in response to the RF received energy being less than the second threshold.

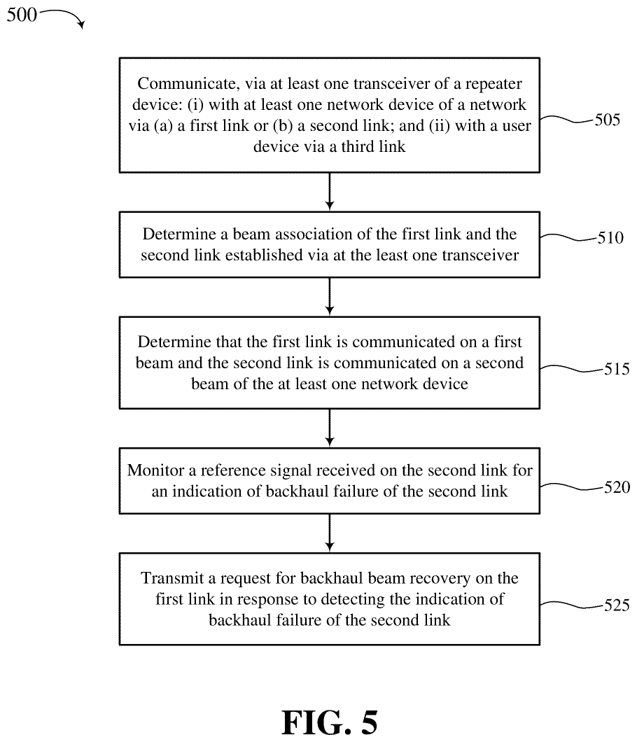

FIG. 5 illustrates a flowchart of a method 500 for wireless communication at a repeater device that detects, indicates, and recovers from a beam failure of a backhaul link, in accordance with aspects of the present disclosure. The operations of the method 500 may be implemented by a device or its components as described herein. For example, the operations of the method 500 may be performed by a repeater device such as NCR device 130 (FIGS. 1-3) or device 402 (FIG. 4). In some implementations, the repeater device may execute a set of instructions to control the function elements of the network device to perform the described functions. Additionally, or alternatively, the user device may perform aspects of the described functions using special-purpose hardware.

At 505, the method 500 may include communicating via at least one transceiver of a repeater device: (i) with at least one network device of a network via (a) a first link or (b) a second link; and (ii) with a user device via a third link. The operations of 505 may be performed in accordance with examples as described herein. In some implementations, aspects of the operations of 505 may be performed by a device as described with reference to FIGS. 1-4.

At 510, the method 500 may include determining a beam association of the first link and the second link established via at the least one transceiver. The operations of 510 may be performed in accordance with examples as described herein. In some implementations, aspects of the operations of 510 may be performed by a device as described with reference to FIGS. 1-4.

At 515, the method 500 may include determining that the first link is communicated on a first beam and the second link is communicated on a second beam of the at least one network device. The operations of 515 may be performed in accordance with examples as described herein. In some implementations, aspects of the operations of 515 may be performed by a device as described with reference to FIGS. 1-4.

At 520, the method 500 may monitoring a reference signal received on the second link for an indication of backhaul failure of the second link. The operations of 520 may be performed in accordance with examples as described herein. In some implementations, aspects of the operations of 520 may be performed by a device as described with reference to FIGS. 1-4.

At 525, the method 500 may include transmitting a request for backhaul beam recovery on the first link in response to detecting the indication of backhaul failure of the second link. The operations of 525 may be performed in accordance with examples as described herein. In some implementations, aspects of the operations of 525 may be performed by a device as described with reference to FIGS. 1-4.

In one or more embodiments, the method 500 may further include receiving, on the first link, a first configuration for beam recovery of the second link. The method 500 may further include applying the first configuration to the at least one transceiver to determine the beam association of the first link and the second link and to monitor the reference signal received on the second link. In one or more particular embodiments, the first configuration includes information about monitoring signal quality of the reference signal transmitted on the second link for beam recovery detection. In one or more particular embodiments, the first configuration that includes a first threshold for comparing to a signal quality value of the reference signal to indicate the backhaul failure. In one or more particular embodiments, the first configuration includes information for sending the request for backhaul beam recovery on an uplink of the first link and includes a beam recovery configuration for receiving a response for beam recovery via a downlink of the first link.

In one or more embodiments, the method 500 may further include detecting the indication of backhaul failure of the second link. In response, the method 500 may further include measuring reference signals respectively received from candidate beams transmitted by the at least one network device. The method 500 may further include comparing the measured reference signals to a first threshold. The method 500 may further include transmitting the requests for backhaul beam recovery on the first link further in response to identifying at least one candidate beam having a corresponding measured reference signal that is greater than the first threshold. In one or more particular embodiments, the method 500 may further include transmitting, within the requests, a corresponding beam identifier for the at least one candidate beam and a corresponding identifier for a Transmission Reception Point (TRP) that transmitted the at least one candidate beam.

In one or more particular embodiments, the method 500 may further include receiving, on the first link, a second configuration comprising a second threshold that is less than the first threshold for handling repeater operation during a beam recovery procedure. The method 500 may further include comparing signal quality of the second link to the second threshold. The method 500 may further include turning off transmissions and receptions by the repeater device on the third link in response to the signal quality being less than the second threshold.

In one or more particular embodiments, the method 500 may further include receiving, on the first link, a second configuration including a second threshold for handling repeater operation during a beam recovery procedure. The method 500 may further include monitoring radio frequency (RF) received energy of the second link. The method 500 may further include comparing the RF received energy of the second link to the second threshold. The method 500 may further include turning off transmissions and receptions by the repeater device on the third link in response to the RF received energy being less than the second threshold.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A repeater device for wireless communication, the repeater device comprising:
at least one memory; and
at least one processor communicatively coupled to the at least one memory and which is configured to cause the repeater device to:
determine a beam association of a first link and a second link established with at least one base station;
monitor a reference signal received on the second link for an indication of backhaul failure of the second link; and
in response to detecting the indication of backhaul failure of the second link, transmit a request for backhaul beam recovery on the first link.

2. The repeater device of claim 1, wherein the at least one processor is further configured to cause the repeater device to:
receive, on the first link, a first configuration for beam recovery of the second link; and
apply the first configuration to the at least one transceiver to determine the beam association of the first link and the second link and to monitor the reference signal received on the second link;
wherein the first link is a control link and the second link is a backhaul link.

3. The repeater device of claim 2, wherein the first configuration comprises information about monitoring signal quality of the reference signal transmitted on the second link for beam recovery detection.

4. The repeater device of claim 2, wherein the first configuration comprises a first threshold for comparing to a signal quality value of the reference signal to indicate the backhaul failure.

5. The repeater device of claim 2, wherein the first configuration comprises information for sending the request for backhaul beam recovery on an uplink of the first link and includes a beam recovery configuration for receiving a response for beam recovery via a downlink on the first link.

6. The repeater device of claim 1, wherein the at least one processor is further configured to cause the repeater device to:
in response to detecting the indication of backhaul failure of the second link:
measure reference signals respectively received from candidate beams transmitted by the at least one base station;
compare the measured reference signals to a first threshold; and
transmit the requests for backhaul beam recovery on the first link further in response to identifying at least one candidate beam having a corresponding measured reference signal that is greater than the first threshold.

7. The repeater device of claim 6, wherein the at least one processor is further configured to cause the repeater device to transmit, within the requests, a corresponding beam identifier for the at least one candidate beam and a corresponding identifier for a Transmission Reception Point (TRP) that transmitted the at least one candidate beam.

8. The repeater device of claim 1, wherein the at least one processor is further configured to cause the repeater device to:
receive, on the first link, a second configuration comprising a second threshold that is less than the first threshold for handling repeater operation during a beam recovery procedure;
compare signal quality of the second link to the second threshold; and
turn off transmissions and receptions by the repeater device on a third link to a user equipment (UE) in response to the signal quality being less than the second threshold, wherein the third link is an access link.

9. The repeater device of claim 1, wherein the at least one processor is further configured to cause the repeater device to:
receive, on the first link, a second configuration comprising a second threshold for handling repeater operation during a beam recovery procedure;
monitor radio frequency (RF) received energy of the second link;
compare the RF received energy of the second link to the second threshold; and
turn off transmissions and receptions by the repeater device on the third link in response to the RF received energy being less than the second threshold.

10. A controller for wireless communication in a repeater device, the controller comprising:
at least one memory; and
at least one processor communicatively coupled to the at least one memory and which is configured to cause the controller to:
determine a beam association of the first link and the second link established via at least one transceiver communicatively coupled to the controller and that enables the repeater device to communicate: (i) with at least one network device of a network via (a) a first link or (b) a second link; and (ii) with a user device via a third link;
monitor a reference signal received on the second link for an indication of backhaul failure of the second link; and
in response to detecting the indication of backhaul failure of the second link, transmit a request for backhaul beam recovery on the first link.

11. The controller of claim 10, wherein the at least one processor is configured to cause the controller to:
receive, on the first link, a first configuration for beam recovery of the second link; and
apply the first configuration to the at least one transceiver to determine the beam association of the first link and the second link and to monitor the reference signal received on the second link;
wherein the first configuration comprises one or more of:
information about monitoring signal quality of the reference signal transmitted on the second link for beam recovery detection;
a first threshold for comparing to a signal quality value of the reference signal to indicate the backhaul failure; and
information for sending the request for backhaul beam recovery on an uplink of the first link, the information including a beam recovery configuration for receiving a response for beam recovery via a downlink of the first link.

12. (canceled)

13. (canceled)

14. The controller of claim 13, wherein the processor is further configured to cause the controller to:
turn off transmissions and receptions by the repeater device on the third link in response to initiation of the beam recovery procedure, wherein the third link is an access link.

15. (canceled)

16. A method for wireless communication at a repeater device, the method comprising:
determining a beam association of a first link and a second link established with at least one base station;
monitoring a reference signal received on the second link for an indication of backhaul failure of the second link; and
in response to detecting the indication of backhaul failure of the second link, transmitting a request for backhaul beam recovery on the first link;
wherein the first link is a control link and the second link is a backhaul link.

17. The method of claim 16, further comprising:
receiving, on the first link, a first configuration for beam recovery of the second link; and
applying the first configuration to the at least one transceiver to determine the beam association of the first link and the second link and to monitor the reference signal received on the second link; and
wherein the first configuration comprises one or more of:
information about monitoring signal quality of the reference signal transmitted on the second link for beam recovery detection;
a first threshold for comparing to a signal quality value of the reference signal to indicate the backhaul failure; and
information for sending the request for backhaul beam recovery on an uplink of the first link, the information including a beam recovery configuration for receiving a response for beam recovery via a downlink of the first link.

18. The method of claim 16, further comprising:
in response to detecting the indication of backhaul failure of the second link:
measuring reference signals respectively received from candidate beams transmitted by the at least one network device;
comparing the measured reference signals to a first threshold; and
transmitting the requests for backhaul beam recovery on the first link further in response to identifying at least one candidate beam having a corresponding measured reference signal that is greater than the first threshold, wherein the transmitting comprises transmitting, within the requests, a corresponding beam identifier for the at least one candidate beam and a corresponding identifier for a Transmission Reception Point (TRP) that transmitted the at least one candidate beam.

19. The method of claim 18, further comprising:
turning off transmissions and receptions by the repeater device on the third link in response to initiation of the beam recovery procedure, wherein the third link is an access link.

20. (canceled)

21. The repeater device of claim 1, wherein the at least one processor is further configured to cause the repeater device to perform the monitoring of the reference signal and transmitting of the request in response to determining that the first link is communicated on a first beam and the second link is communicated on a second beam of the at least one base station.

22. The repeater device of claim 1, wherein the at least one processor is further configured to cause the repeater device to:
turn off transmissions and receptions by the repeater device on a third link to a user equipment (UE) in response to initiation of the beam recovery procedure, wherein the third link is an access link.

23. The controller of claim 10, wherein the at least one processor is configured to cause the controller to monitor the reference signal and transmit the request in response to determining that the first link is communicated on a first beam and the second link is communicated on a second beam of the at least one base station.

24. The method of claim 16, wherein the monitoring of the reference signal and the transmitting of the request are completed in response to determining that the first link is communicated on a first beam and the second link is communicated on a second beam of the at least one base station.
